(19) United States
(12) Patent Application Publication
(10) Pub. No.: US 2015/0245964 A1
(43) Pub. Date: Sep. 3, 2015

(54) WHEELCHAIR BACKREST HAVING POSITION ADJUSTMENT

(71) Applicant: SUNRISE MEDICAL (US) LLC, Fresno, CA (US)

(72) Inventor: Vasily G. Tsuber, Thornton, CO (US)

(73) Assignee: SUNRISE MEDICAL (US) LLC, Fresno, CA (US)

(21) Appl. No.: 14/635,173

(22) Filed: Mar. 2, 2015

Related U.S. Application Data
(60) Provisional application No. 61/946,737, filed on Mar. 1, 2014.

(51) Int. Cl. A61G 5/10

(52) U.S. Cl. CPC A61G 5/1067; A61G 2005/122

(57) ABSTRACT

An adjustable backrest support provides a seat back angle adjustment that eases the task of adjusting the position of a wheelchair backrest while keeping the user seated in their wheelchair. In one embodiment, the adjustable backrest support includes a strut, an adjuster ring, an adjusting barrel nut, an angle adjuster, and a clamping system including a clamp. The clamp may include clamping screws that permit adjustment of the seat back reclining angle the angle or the seat back lateral position when loosened.

### CROSS-REFERENCE TO RELATED APPLICATIONS

This application claims the benefit of U.S. Provisional Application No. 61/946,737, filed Mar. 1, 2014, the disclosure of which is incorporated herein by reference.

### BACKGROUND OF THE INVENTION

This invention relates in general to wheelchairs. In particular, this invention relates to an angle adjustable backrest support for a wheelchair. This invention further relates to an angle adjustable backrest support for a wheelchair that also provides lateral positioning of the seat back relative to the seat base.

Wheelchairs are typically intended to be used by persons having different size, physical constitutions, and impairments. These conditions are accommodated, in one respect, by providing adjustable seating systems that permit the seat and/or seat back to be positioned to the user's seated body contours. Many known seating systems provide a variety of adjustments but often require the user to be moved away from the seat portion to be adjusted. Thus, it would be desirable to provide a seat backrest adjustment mechanism that is easily adjustable, even when the user is seated.

### SUMMARY OF THE INVENTION

This invention relates to wheelchairs and, in particular, to adjustable backrests for wheelchairs. In one aspect of the invention, there is disclosed a wheelchair having a frame. In certain embodiments, the frame may include spaced apart side frame tubes. A strut is connected to the frame. An adjustable backrest support engages the strut such that the adjustable backrest support pivots angularly about the strut. The adjustable backrest support may be fixed in one of a plurality of angled positions. The adjustable backrest support may further be moveable along the strut and fixed in one of a plurality of lateral positions between the side frame tubes.

In certain embodiments, a backrest is mounted for selective angular movement relative to the adjustable backrest support. The backrest is also mounted for selective axial movement relative to the adjustable backrest support and may be fixed in one of a plurality of height positions relative to the frame. In one embodiment, the selective angular movement may be an inclination angular movement relative to a side view of the frame. In other embodiments, selective angular movement may be a rotational angular movement substantially within a plane generally parallel to the adjustable backrest support.

The adjustable backrest support includes a backrest riser that supports a seat back mount for selective axial movement to the plurality of height positions. The seat back mount has a hinge and an adjuster connection to selectively provide inclination angular movement. The adjustable backrest support includes a backrest reclining mount having an aperture that engages the strut and permits the angular pivoting movement about the strut and lateral movement along the strut of the support and backrest. An adjuster ring is disposed between the strut and the backrest reclining mount. The adjuster ring is rotationally fixed relative to the strut and moveable along the strut. The strut has a torque transmitting profile and the adjuster ring includes an aperture having a complementary profile that engages the strut. In certain embodiments, the strut is attached to opposing backrest mounting brackets that are selective attachable to the frame in one of a plurality of longitudinal mounting positions that define a seat depth. In other embodiments, the strut may be directly mounted to the frame.

In certain embodiments, the backrest reclining mount includes a strut clamp positioned proximate to the aperture. The strut clamp including a pinch bolt and a deflection slot that cooperate to selectively fix the position of the backrest reclining mount relative to the strut. In certain other embodiments, the strut clamp may be two spaced apart strut clamps on opposite sides of a ring slot in the backrest reclining mount. The ring slot is shaped to accept the adjuster ring. The adjuster ring engages an angle adjuster that defines an adjustable support to maintain a previously set adjustment when the pinch bolt is loosened. The adjuster ring is positioned within the ring slot such that the adjuster ring aperture is coaxially aligned with the backrest reclining mount aperture, the adjuster ring engaging the angle adjuster such that movement of the angle adjuster causes the adjustable backrest support to rotate about the strut. In certain embodiments, the backrest reclining mount aperture further includes a limiter slot that limits a range of motion of the adjustable backrest support relative to the strut.

In certain embodiments, the adjuster ring includes an adjuster slot that supports a barrel nut for relative rotational movement and constrained axial movement within the adjuster slot. The angle adjuster has a threaded portion that engages the barrel nut such that rotation of the angle adjuster rotates the adjustable backrest support relative to the strut.

In another aspect of the invention, an adjustable wheelchair backrest assembly includes a backrest configured to support a user. The adjustable wheelchair backrest assembly further includes an adjustable backrest support having a backrest reclining mount and a backrest riser. The backrest reclining mount has an aperture and a strut clamp. A strut extends through the backrest reclining mount aperture in selective engagement with the strut clamp. The strut supports the adjustable backrest support for selective angular pivotal movement. The strut also supports the adjustable backrest support for axial movement along the strut to a plurality of lateral positions. A seat back mount is connected to the backrest. The seat back mount has a hinge pivotally connected to a slide block and a locking arm adjustably connected to the slide block to position the backrest in one of a plurality of inclination angle positions. The slide block engages the backrest riser for selective movement along the backrest riser to position the backrest in one of a plurality of height positions. In certain embodiments, the seat back mount is a compound angle seat back mount that permits the backrest to be rotated to a desired angle substantially within a plane generally parallel to the backrest riser.

The strut includes a torque transmitting profile. The backrest reclining mount has a slot intersecting the backrest reclining mount aperture. The slot cooperates with the strut clamp to selectively fix the axial position of the adjustable backrest support relative to the strut. An adjuster ring is connected to the backrest reclining mount and engages the strut for selective angular reclining movement of the backrest.

In yet another aspect of the invention, an adjustable backrest support for a wheelchair includes a strut, a clamp, an adjuster ring, and an angle adjuster. The strut has a torque resistive shape and spaced apart frame attachment ends. The clamp has an aperture configured to mate with the strut and at least one pinch bolt to selectively fix the clamp to the strut. The adjuster ring mates with the strut such that the adjuster ring can be moved laterally across the strut and is rotationally fixed relative to the strut. The angle adjuster cooperates with the adjuster ring and the clamp such that movement of the angle adjuster positions the clamp in an angular position relative to a wheelchair frame.

In certain embodiments, the adjuster ring and angle adjuster cooperate to move a backrest reclining mount to one of a plurality of angular positions relative to the wheelchair frame and maintain the angular position when the clamp is moved to a released position. The clamp released position permits the backrest reclining mount to be axially moved along the strut to one of a plurality of lateral positions relative to the wheelchair frame.

Various aspects of this invention will become apparent to those skilled in the art from the following detailed description of the preferred embodiment, when read in light of the accompanying drawings.

### BRIEF DESCRIPTION OF THE DRAWINGS

FIG. 1 is a side view of an embodiment of an adjustable backrest support for a wheelchair in accordance with the invention.

FIG. 2 is an exploded, perspective view of an embodiment of a backrest adjustment mount.

FIG. 3 is a side view, in partial cross section, of the backrest adjustment mount of FIG. 2 in a first position.

FIG. 4 is a side view, in partial cross section, of the backrest adjustment mount of FIG. 3 in a forward angle-adjusted position.

FIG. 5 is a side view, in partial cross section, of the backrest adjustment mount of FIG. 3 in a rearward angle-adjusted reclining position.

FIG. 6 is an exploded, side view of a portion of an embodiment of the backrest adjustment mount of FIG. 3.

FIG. 7 is an exploded, side view of a portion of another embodiment of the backrest adjustment mount of FIG. 3.

FIG. 8 is an exploded, side view of a portion of yet another embodiment of the backrest adjustment mount of FIG. 3.

FIG. 9 is an exploded, side view of a portion of yet another embodiment of the backrest adjustment mount of FIG. 3.

FIG. 10 is a rear facing, elevational view of another embodiment of an adjustable backrest support for a wheelchair having a lateral adjustability.

FIG. 11 is a side view of a portion of an embodiment of an adjustable backrest support for a wheelchair having a backrest

FIG. 12A is a rear facing, elevational view of another embodiment of an adjustable backrest support for a wheelchair having a second angle adjustment bracket assembly.

FIG. 12B is an exploded, side view of an embodiment of the second angle adjustment bracket assembly of FIG. 12A.

### DETAILED DESCRIPTION OF THE PREFERRED EMBODIMENT

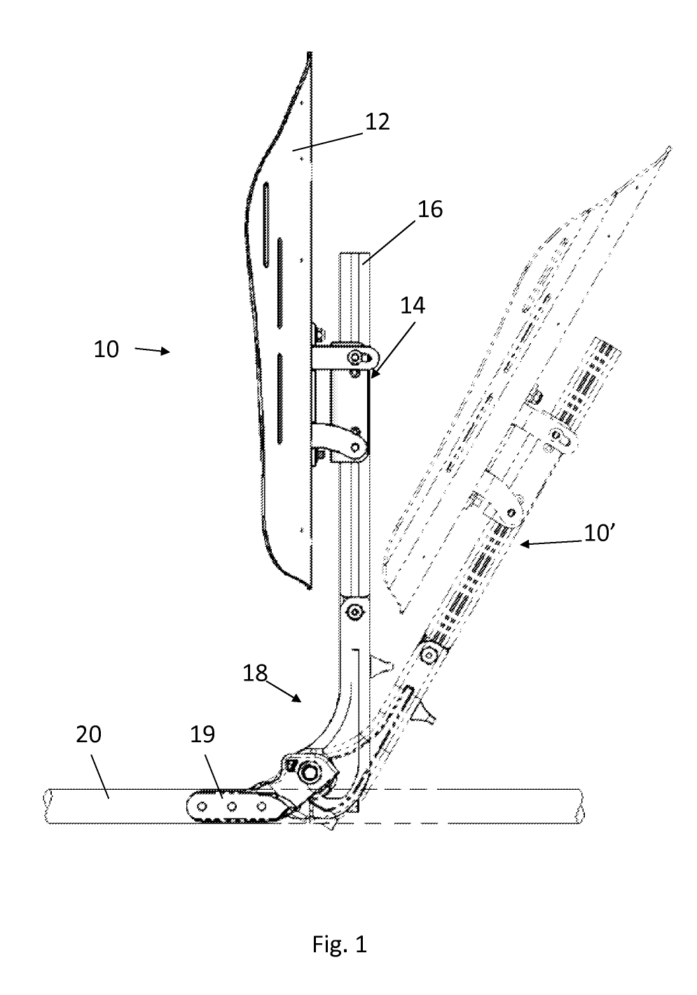

Referring now to the drawings, there is illustrated in FIG. 1 an adjustable backrest support for a wheelchair, shown generally at 10. The adjustable backrest support includes a backrest or seat back 12 connected to a seat back mount 14. The seat back mount 14 is connected to a backrest riser 16 such that the backrest 12 is adjustable in a number of different height positions. The backrest riser 16 is connected to a backrest reclining mount, shown generally at 18, that is supported on a wheelchair frame 20 by a backrest mounting bracket 19. In one embodiment, the wheelchair frame 20 includes spaced apart side frame tubes. The backrest reclining mount 18 permits the recline angle of the backrest 12 to be adjusted relative to the wheelchair frame 20. As shown in FIG. 1, the backrest reclining mount 18 permits movement of the backrest support 10 from an upright position (shown in solid lines) to a reclined position of the backrest support 10′ (shown in dashed lines).

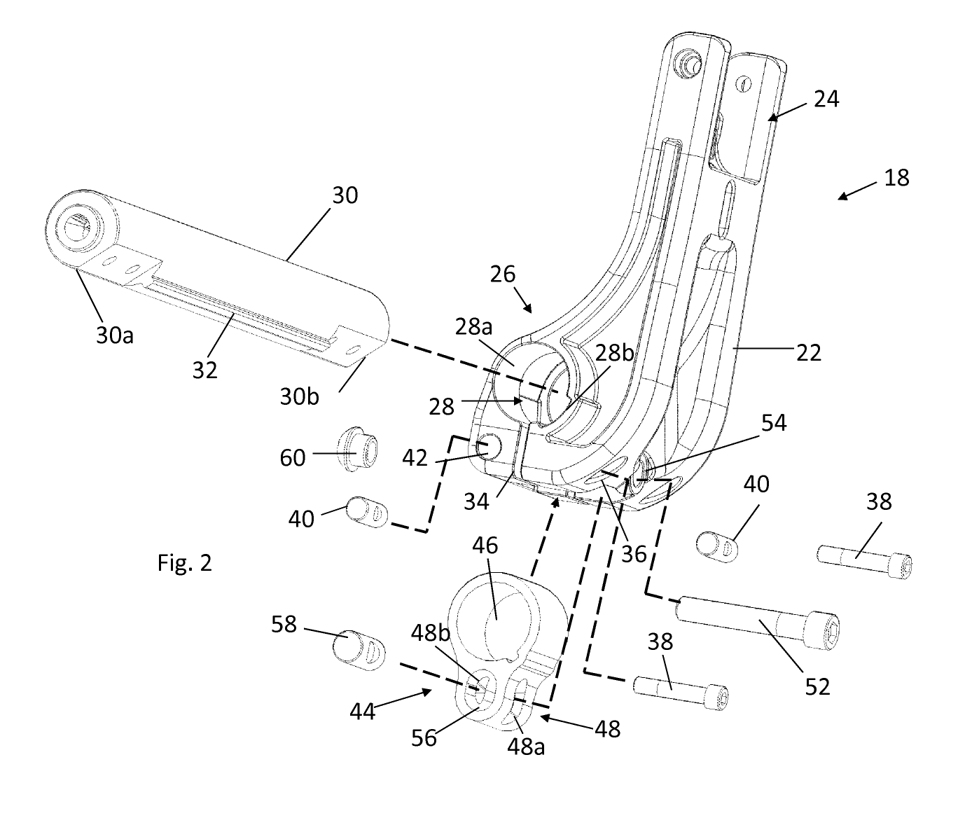

Referring now to FIG. 2, the backrest reclining mount 18 includes a clamp 22 having a riser mount 24 and a strut clamp 26. The riser mount 24 is configured to retain the backrest riser 16 and support user applied loads from the backrest 12. The strut clamp 26 includes an aperture 28 having a circumferential profile 28a that is configured to mate with a strut 30 having a torque transmitting or torque resistive profile 32. In one embodiment, the strut 30 further includes attachment ends 30a and 30b that attach to the backrest mounting bracket 19. The backrest mounting bracket 19 may connect to the wheelchair frame 20 in a number of lengthwise or longitudinal mounting positions that vary the depth of seating. In one embodiment, the strut 30 and mounting bracket 19 may be configured as a cross member that connects two sides, such as left and right sides of frame 20 together. In this way, mounting and reclining movement of the backrest assembly 10 is independent of any back cane structures (not shown). Though shown as a radially extending key, the torque transmitting profile 32 may be any suitable shape that is capable of transmitting a torque load applied thereto. In the illustrated embodiment, the circumferential profile 28a of the aperture 28 further includes a limiter slot 28b that cooperates with the strut 30 to permit assembly of the strut 30 through the aperture 28. The limiter slot 28b is sized to permit the torque transmitting profile 32 of the strut 30 to be rotated through a range of motion relative to the aperture 28. In certain embodiments, the limiter slot 28b may also act to limit the overall range of reclining motion of the backrest assembly 10.

The clamp 22 includes a deflection slot 34 or “saw slot” that permits the circumference of the aperture 28 to close around and firmly grip the mating surface of the strut 30. The aperture 28 may be positioned, as shown, on both sides of the clamp 22 or may be a single aperture, either on one side or centrally located in the strut clamp 26. Associated with the aperture 28 is a pinch bolt hole 36. The pinch bolt hole 36 intersects the deflection slot 34 such that a pinch bolt 38 can draw the aperture 28 around the strut 30. In the illustrated embodiment, a clamping barrel nut 40 is disposed in a hole 42, that also intersects the pinch bolt hole 36 and is configured to engage the pinch bolt 38 to permit clamping of the clamp 22 to the strut 30. Alternatively, a threaded end of the pinch bolt hole 36 or a conventional nut (not shown) may be substituted for the clamping barrel nut 40.

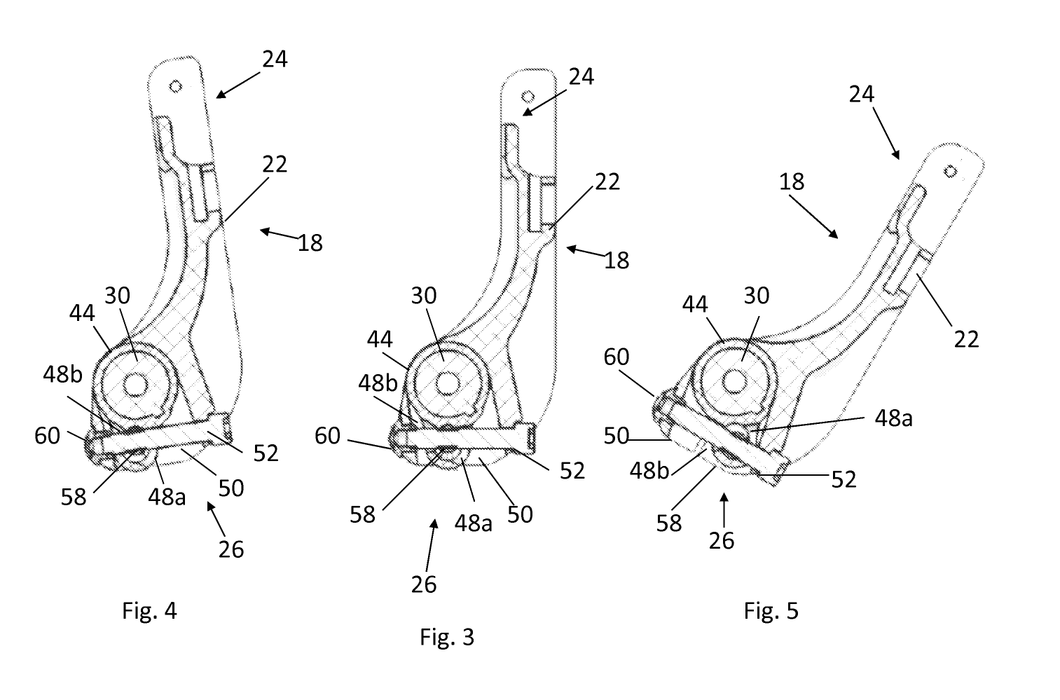

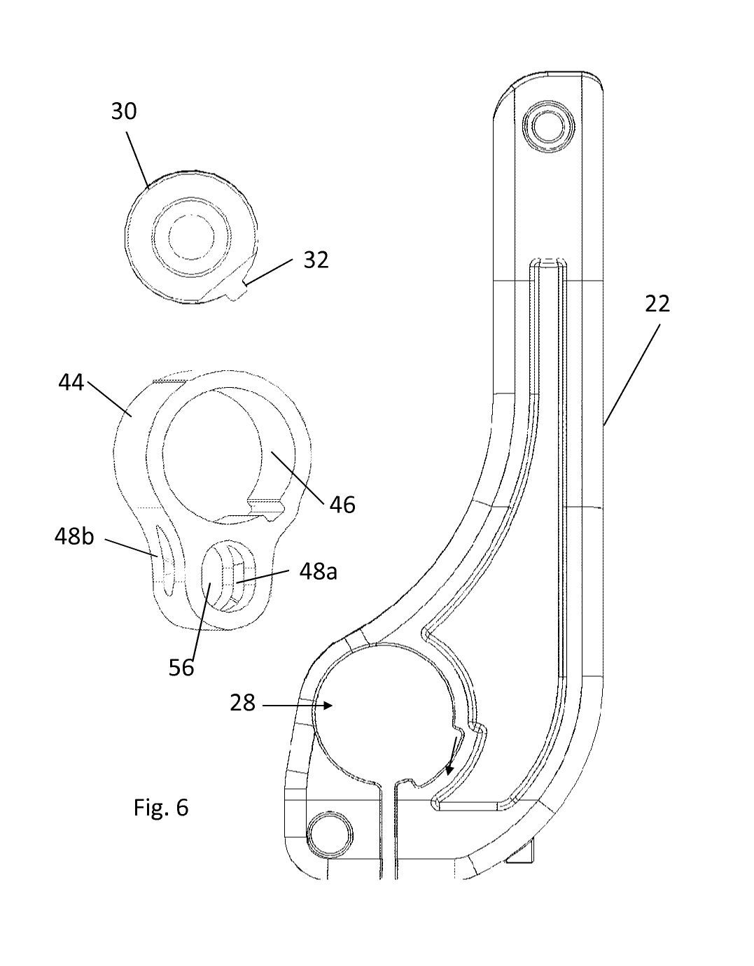

An adjuster ring, shown generally at 44, includes a strut aperture 46 and an adjuster slot 48. The adjuster ring 44 is configured to be inserted into a ring slot 50 , formed in the clamp 22 between the apertures 28, as shown in FIGS. 3-5. Alternatively, if the aperture 28 is centrally located on the strut clamp 26, the ring slot 50 may be one or two ring slots positioned where the apertures 28 are illustrated in FIG. 2. The adjuster ring 44 is inserted into the ring slot 50 such that the strut aperture 46 is generally in coaxial alignment with the apertures 28. The strut aperture 46 is shaped so as to permit the strut 30 to extend therethrough and generally conform to the outer shape of the strut 30 and the torque transmitting profile 32, as shown in the enlarged view of FIG. 6. The adjuster slot 48 is illustrated as a pair of spaced-apart oblong holes 48a and 48b, as shown in FIGS. 3-5, that accept an angle adjuster 52. Alternatively, the adjuster slot 48 may be opened at the bottom, if desired. In the illustrated embodiment, the angle adjuster 52 is a shown as a threaded bolt though other structures may be used, if so desired. The angle adjuster 52 passes through an adjustment aperture 54 in the strut clamp 26. The adjuster slot 48 includes an oblong nut aperture 56 that accepts an adjusting barrel nut 58 that threads onto the angle adjuster 52. As shown in FIGS. 3-5, the nut aperture 56 permits the adjusting barrel nut 58 to move toward or away (illustrated as clockwise or counterclockwise rotation) from the strut 30 as the angle adjuster 52 is rotated. The end of the angle adjuster 52 may be supported, relative to the clamp 22, by a cap 60 that may act as a bushing to locate the angle adjuster within the strut clamp 26 and also permit rotation of the angle adjuster 52.

As shown in FIGS. 3-5, rotation of the angle adjuster 52 relative to the adjusting barrel nut 58 rotates the clamp 22 about the strut 30. Prior to adjustment, the pinch bolts 38 are moved to release the apertures 28 from the clamped position around the strut 30. As shown in FIG. 3, the angle adjuster 52 is threaded into the adjusting barrel nut 58, which is located within the adjuster slot 48. When the angle adjuster 52 is rotated in one direction, the adjusting barrel nut 58 moves along the angle adjuster 52 and against the sides of the nut aperture 56. This movement is enabled by the strut 30 being fixed to the wheelchair frame 20 and the strut aperture 46 of the adjusting ring 44 having a complementary profile to that of the torque transmitting profile 32 of the strut 30. Additionally, the angle adjuster 52 may push against the strut clamp surface 26 in one direction and the cap 60 pushing during rotation in the opposite direction. As shown in FIG. 4, rotation of the angle adjuster 52 (counterclockwise for a right-hand threaded angle adjuster 52) rotates the clamp 22, and thus the backrest 12 to a forward tilted position. Rotating the angle adjuster 52 in the opposite direction moves the clamp 22 to the reclined position shown in FIG. 5. The clamp 22 may adjusted to any intermediate angular position and fixed relative to the strut 30 by way of the pinch bolts 38.

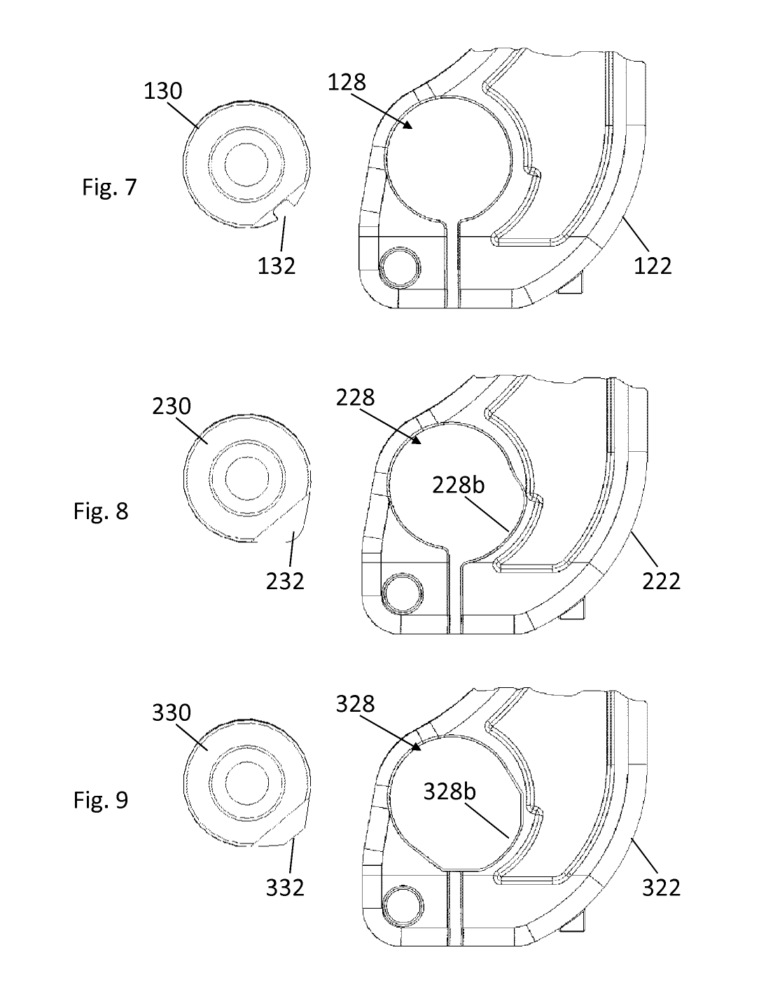

Referring to FIGS. 7-9, there are illustrated different examples of various embodiments of torque transmitting profiles and corresponding strut apertures. It should be understood that these examples are not exhaustive of the shapes that may be used in accordance with various embodiments of the invention. It should be further understood that a corresponding adjuster ring (not shown) will have a strut aperture having a mating profile with the torque transmitting profile of the strut, as described above in the previous embodiment. FIG. 7 illustrates a strut 130 having a keyway 132. A clamp 122 having a round aperture 128. may be provided without a limiter slot. Movement of the clamp 122 may be limited at either extremes of travel by the adjuster ring (not shown) locating against the ring slot (not shown) as illustrated in FIGS. 3-5. FIG. 8 illustrates a strut 230 having a cam profile 232 and a clamp 222 having an aperture 228 and a limiter slot 228b. FIG. 9 illustrates a strut 330 having a portion of a hexagonal profile 332 and a clamp 322 having an aperture 328 and a limiter slot 328b.

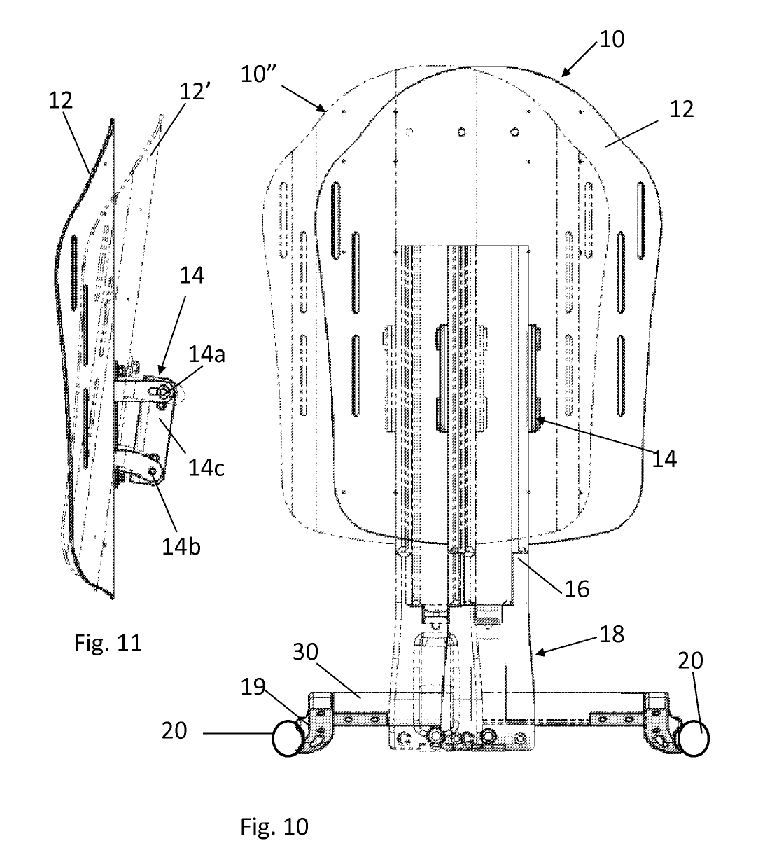

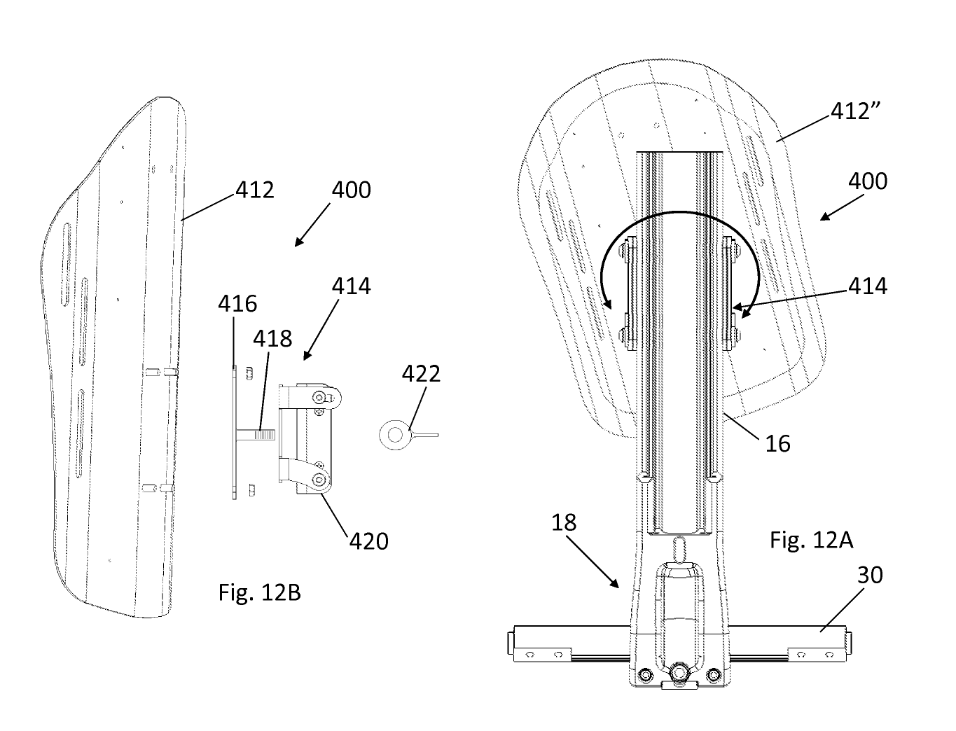

Referring now to FIG. 10, the strut 30 is sufficiently long to provide a lateral adjustment of the backrest 12 relative to the wheelchair frame 20. When the backrest reclining mount 18 is loosened (by way of the pinch bolts), the adjustable backrest support 10 may be moved to a second lateral position 10″. This adjustment permits compensation for users having spine curvature issues or an inability to sit upright in the chair. As shown in FIG. 11, the backrest 12 may be mounted to the seatback mount 14, where the seatback mount 14 includes a hinge connection 14a and an adjuster connection 14b to provide an angular adjustment of the backrest 12 relative to the backrest riser 16, for added comfort. The adjuster connection 14b is configured as a slotted locking arm extending from the backrest 12 that can be fixed in a plurality of inclination angles relative to a slide block 14c by way of a fastener, such as a bolt and nut, over-center clamp, or other locking arrangement. Alternatively, the slot may be formed in the slide block 14c, if so desired. The slide block 14c is configured to axially move along the backrest riser 16 to vary the height position of the backrest 12 relative to the frame 20. The inclination angle of the backrest 12 may be moved to a second position 12′. Referring to FIGS. 12A and 12B, another embodiment of an adjustable backrest support 400 may include a backrest 412 attached to a compound angle seatback mount 414. The compound angle seatback mount 414 includes a pivot mounting plate 416 that attaches to the backrest 412. The pivot mounting plate 416 includes a pivot stem 418 that attaches to a seatback angle adjusting bracket 420, similar to the seatback mount 14. An adjusting lever 422 permits the backrest 412 to be rotated to a desired angle substantially within a plane generally parallel to the backrest riser 16, to a position such as backrest position 412″.

The principle and mode of operation of this invention have been explained and illustrated in its preferred embodiment. However, it must be understood that this invention may be practiced otherwise than as specifically explained and illustrated without departing from its spirit or scope.

What is claimed is:

1. A wheelchair comprising:
a frame having spaced apart side frame tubes;
a strut connected to the frame; and
an adjustable backrest support engaging the strut such that the adjustable backrest support pivots angularly about the strut and configured to be fixed in one of a plurality of angled positions and moveable along the strut and configured to be fixed in one of a plurality of lateral positions between the side frame tubes.

2. The wheelchair of claim 1 wherein a backrest is mounted for selective angular movement relative to the adjustable backrest support and mounted for selective axial movement relative to the adjustable backrest support and configured to be fixed in one of a plurality of height positions relative to the frame.

3. The wheelchair of claim 2 wherein the selective angular movement is an inclination angular movement relative to a side view of the frame.

4. The wheelchair of claim 2 wherein the selective angular movement is a rotational angular movement substantially within a plane generally parallel to the adjustable backrest support.

5. The wheelchair of claim 3 wherein the adjustable backrest support includes a backrest riser that supports a seat back mount for selective axial movement to the plurality of height positions, the seat back mount further having a hinge and an adjuster connection to selectively provide the inclination angular movement.

6. The wheelchair of claim 1 wherein the adjustable backrest support includes a backrest reclining mount having an aperture configured to engage the strut and permit the angular pivoting movement about the strut and lateral movement along the strut.

7. The wheelchair of claim 6 wherein an adjuster ring is disposed between the strut and the backrest reclining mount, the adjuster ring being rotationally fixed relative to the strut and moveable along the strut.

8. The wheelchair of claim 7 wherein the strut has a torque transmitting profile and the adjuster ring includes an aperture having a complementary profile that engages the strut.

9. The wheelchair of claim 6 wherein the backrest reclining mount includes a strut clamp positioned proximate to the aperture, the strut clamp including a pinch bolt and a deflection slot that cooperate to selectively fix the position of the backrest reclining mount relative to the strut.

10. The wheelchair of claim 9 wherein the backrest reclining mount includes a ring slot configured to accept the adjuster ring, the adjuster ring engages an angle adjuster, the angle adjuster defining an adjustable support that maintains a previous set adjustment when the pinch bolt is loosened.

11. The wheelchair of claim 9 wherein the backrest reclining mount includes a ring slot configured to accept the adjuster ring such that the adjuster ring aperture is coaxially aligned with the backrest reclining mount aperture, the adjuster ring engaging the angle adjuster such that movement of the angle adjuster causes the adjustable backrest support to rotate about the strut.

12. The wheelchair of claim 11 wherein the backrest reclining mount aperture further includes a limiter slot that limits a range of motion of the adjustable backrest support relative to the strut.

13. The wheelchair of claim 11 wherein the adjuster ring includes an adjuster slot that supports a barrel nut for relative rotational movement and constrained axial movement within the adjuster slot, the angle adjuster having a threaded portion that engages the barrel nut such that rotation of the angle adjuster rotates the adjustable backrest support relative to the strut.

14. The wheelchair of claim 1 wherein the strut is attached to opposing backrest mounting brackets that are selective attachable to the frame in one of a plurality of longitudinal mounting positions that define a seat depth.

15. The wheelchair of claim 1 wherein the strut is directly mounted to the frame.

16. An adjustable wheelchair backrest assembly comprising:
a backrest configured to support a user;
an adjustable backrest support having a backrest reclining mount and a backrest riser, the backrest reclining mount having an aperture and a strut clamp;
a strut extending through the backrest reclining mount aperture and in selective engagement with the strut clamp, the strut supporting the adjustable backrest support for selective angular pivotal movement and supporting the adjustable backrest support for axial movement along the strut to a plurality of lateral positions; and
a seat back mount connected to the backrest, the seat back mount having a hinge pivotally connected to a slide block and a locking arm adjustably connected to the slide block to position the backrest in one of a plurality of inclination angle positions, the slide block engaging the backrest riser for selective movement along the backrest riser to position the backrest in one of a plurality of height positions.

17. The adjustable wheelchair backrest assembly of claim 16 wherein the seat back mount is a compound angle seat back mount that permits the backrest to be rotated to a desired angle substantially within a plane generally parallel to the backrest riser.

18. The adjustable wheelchair backrest assembly of claim 16 wherein the strut includes a torque transmitting profile, and the backrest reclining mount has a slot intersecting the backrest reclining mount aperture, the slot cooperating with the strut clamp to selectively fix the axial position of the adjustable backrest support relative to the strut, and an adjuster ring connected to the backrest reclining mount and engaging the strut for selective angular reclining movement of the backrest.

19. An adjustable backrest support for a wheelchair comprising:
a strut having a torque resistive shape and spaced apart frame attachment ends;
a clamp having an aperture configured to mate with the strut and at least one pinch bolt configured to selectively fix the clamp to the strut;
an adjuster ring configured to mate with the strut such that the adjuster ring can be moved laterally across the strut and is rotationally fixed relative to the strut; and
an angle adjuster that cooperates with the adjuster ring and the clamp such that movement of the angle adjuster positions the clamp in an angular position relative to a wheelchair frame.

20. The adjustable backrest support of claim 19 wherein the adjuster ring and angle adjuster cooperate to move a backrest reclining mount to one of a plurality of angular positions relative to the wheelchair frame and maintain the angular position when the clamp is moved to a released position, the released position permitting the backrest reclining mount to be axially moved along the strut to one of a plurality of lateral positions relative to the wheelchair frame.
